(19) United States
(12) Patent Application Publication
(10) Pub. No.: US 2009/0313814 A1
(43) Pub. Date: Dec. 24, 2009

(54) METHOD OF PRODUCING NONAQUEOUS SECONDARY BATTERY

(76) Inventor: Yasushi Tsuchida, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/373,544

(22) PCT Filed: Sep. 6, 2007
(86) PCT No.: PCT/JP2007/067432

§ 371 Date: Jan. 13, 2009

(30) Foreign Application Priority Data
Sep. 7, 2006 (JP) 2006-242764

(51) Int. Cl. H01M 10/04

(52) U.S. Cl. 29/623.5

(57) ABSTRACT

A main object of the present invention is to provide a method of producing a nonaqueous secondary battery which can produce a nonaqueous secondary battery while restraining the formation of oxide film on the anode layer surface. To attain the object, the present invention provides a method of producing a nonaqueous secondary battery comprising steps of: an anode layer forming step of forming an anode layer of metal thin film on an anode current collector; an oxide film removing step of removing an oxide film formed on the anode layer surface; a drying step of drying the anode layer, from which the oxide film is removed, under an inert gas atmosphere; a cooling step of cooling the dried anode layer under an inert gas atmosphere; a transfer step of transferring the cooled anode layer to an assembling area: and an assembling step of assembling a nonaqueous secondary battery under an inert gas atmosphere by using the anode layer transferred to the assembling area.

### TECHNICAL FIELD

The present invention relates to a method of producing a nonaqueous secondary battery, wherein a nonaqueous secondary battery having high initial charge-discharge efficiency and a high capacity can be obtained.

### BACKGROUND ART

As devices such as personal computers, video cameras, and cell phones are downsized in the fields of information-related devices and communication devices, lithium secondary batteries have been practically and widely used as power sources in these devices because of high energy density. Meanwhile, in the field of automobiles, there are demands for urgent development of electric vehicles because of environmental and resources problems, and lithium secondary batteries have also been examined as power sources for such electric vehicles.

Carbon materials such as graphite have been widely used as anode active materials used for lithium secondary batteries. As carbon materials have less Li storage capacity in general, metal thin films such as Sn and Sn alloy are attracting attentions because they have more Li storage capacity compare to carbon materials. When such metal thin films are used as anode layers and oxide films are formed on the metal thin film surfaces, however, there is a problem of unreversible reaction as illustrated below so that electrolyte ions are consumed at the time of initial charge.

MOₓ+2xA⁺→M+xAO (in which, “M” denotes an anode metal (For example, Sn), “A” denotes an electrolyte ion (For example, Li ion)).

When the unreversible reaction is caused, on the surface, it seems that the Li ions are stored in the anode at the time of initial charge. However, Li ions cannot be formed from Li₂O and therefore it is problematic that the capacity of nonaqueous secondary battery becomes lower.

To respond such problems, the Patent Document 1 discloses a technology regarding a battery comprising a metallic element in an anode which can store and discharge Li, wherein an electrolyte has a first lithium salt having a specific structure and a second lithium salt. In this technology, a stable film is formed on the anode by using the first lithium salt having a specific structure, and thereby the unreversible reaction caused between the anode and the electrolyte solution is restricted. By further having the second lithium salt in the electrolyte, high ion conductivity cab be achieved. In this technology, however, as the lithium salt of the special structure needed to be added and thus has a problem of lucking versatility.

The Patent Document 2 discloses a technology regarding an electrode material for a lithium secondary battery which has a silicone anode, wherein the average particle size of the electrode material is within a specific range. In this technology, the average particle size of the electrode material is made 0.1 μm or more to lessen the surface area per unit volume so that lowering in initial efficiency of oxidation reaction or of attaching/detaching lithium can be restrained. It is thought that lessening of the surface area per unit volume can lessen the contact area to the air and thereby restrict the oxidation reaction. At the same time, however, this lessens the contact area to the electrolyte solution and reduces the electrode reaction area so that a problem of lowering the battery output is occurred.

Patent Document 1: Japanese Patent Application Laid-Open (JP-A) No. 2005-79057

Patent Document 2: JP-A No. 2004-185810

### DISCLOSURE OF INVENTION

### Problem to be Solved by the Invention

The present invention is achieved in view of the above-mentioned problems, and a main object thereof is to provide a method of producing a nonaqueous secondary battery which can produce a nonaqueous secondary battery while restraining the formation of oxide film on the anode layer surface.

### Means for Solving the Problems

To attain the object, the present invention provides a method of producing a nonaqueous secondary battery comprising steps of: an anode layer forming step of forming an anode layer of metal thin film on an anode current collector; an oxide film removing step of removing an oxide film formed on the anode layer surface; a drying step of drying the anode layer, from which the oxide film is removed, under an inert gas atmosphere; a cooling step of cooling the dried anode layer under an inert gas atmosphere; a transfer step of transferring the cooled anode layer to an assembling area: and an assembling step of assembling a nonaqueous secondary battery under an inert gas atmosphere by using the anode layer transferred to the assembling area.

According to the present invention, formation of an oxide film at the time of transferring the anode can be restrained by conducting the cooling step of cooling the dried anode layer. Thereby, the above-mentioned unreversible reaction in which electrolytic ions are consumed at the time of initial charging becomes less likely to be occurred and a nonaqueous secondary battery excellent in initial charge-discharge efficiency can be obtained.

In the above-mentioned invention, the anode layer is preferably cooled to a temperature of 10° C. or lower in the cooling step. Thereby, formation of the oxide film can be restrained.

In the above-mentioned invention, the cooled anode layer is preferably maintained at 10° C. or lower in the transfer step. Thereby, formation of the oxide film can be more restrained compare to the case of transferring the cooled anode layer at ordinary temperature.

In the above-mentioned invention, the cooled anode layer is preferably transferred to the assembling area under an inert gas atmosphere in the transfer step. By transferring under the inert gas atmosphere, formation of the oxide film can be restrained.

In the above-mentioned invention, the anode layer is preferably cooled at 15° C. or lower in the assembling step. Thereby, formation of the oxide film can be restrained.

### EFFECT OF THE INVENTION

The present invention attains an effect of obtaining a nonaqueous secondary battery which has high initial charge-discharge efficiency and high capacity.

### BRIEF DESCRIPTION OF DRAWINGS

FIG. 1 is an illustration of the method of producing a nonaqueous secondary battery of the present invention.

FIG. 2 is a graph showing the relationship between the temperature (° C.) and the initial charge-discharge efficiency (%) of the coin type cells obtained in the Examples and the Comparative Example.

### BEST MODE FOR CARRYING OUT THE INVENTION

Hereinafter, the method of producing a nonaqueous secondary battery of the present invention is described in detail.

The method of producing a nonaqueous secondary battery of the present invention comprises steps of: an anode layer forming step of forming an anode layer of metal thin film on an anode current collector; an oxide film removing step of removing an oxide film formed on the anode layer surface; a drying step of drying the anode layer, from which the oxide film is removed, under an inert gas atmosphere; a cooling step of cooling the dried anode layer under an inert gas atmosphere; a transfer step of transferring the cooled anode layer to an assembling area: and an assembling step of assembling a nonaqueous secondary battery under an inert gas atmosphere by using the anode layer transferred to the assembling area.

According to the present invention, formation of an oxide film at the time of transferring the anode can be restrained by conducting the cooling step of cooling the dried anode layer. Thereby, the above-mentioned unreversible reaction in which electrolytic ions are consumed at the time of initial charging becomes less likely to be occurred and a nonaqueous secondary battery excellent in initial charge-discharge efficiency can be obtained. Further, as the anode layer of metal thin film is used, a nonaqueous secondary battery having higher capacity can be obtained compare to other cases such as where an anode layer with a powdery anode active material fixed by a binder is used.

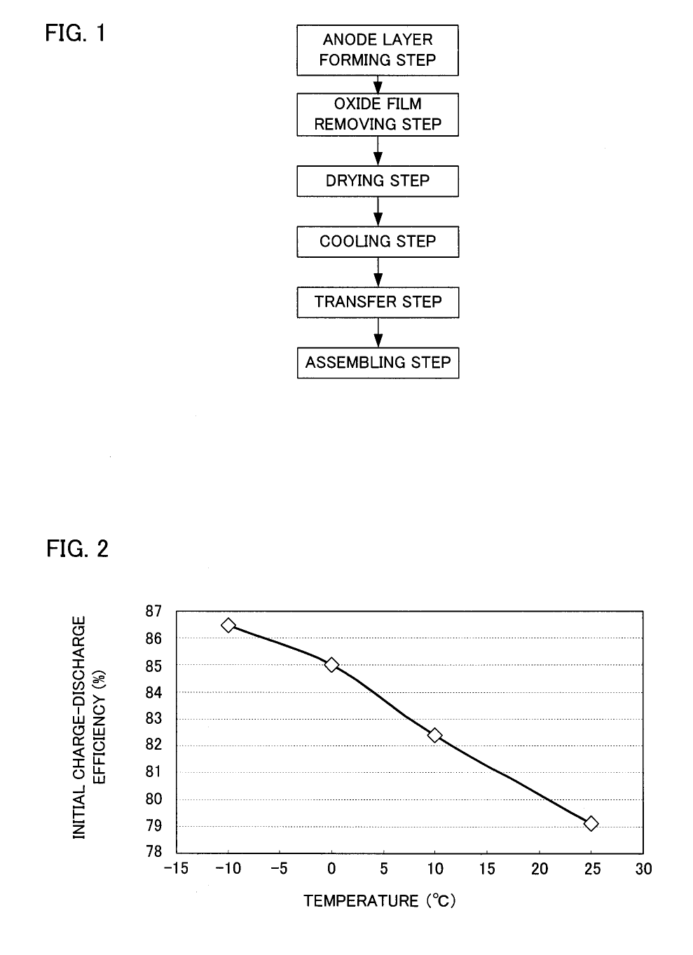

Next, the method of producing a nonaqueous secondary battery of the present invention will be explained with a reference to the drawings. FIG. 1 is an illustration of the method of producing a nonaqueous secondary battery of the present invention. The method of producing a nonaqueous secondary battery of the present invention comprises the following steps: a step of forming an anode layer of metal thin film on an anode current collector by a method such as a sputtering method (anode layer forming step); a step of removing an oxide film formed on the obtained anode layer surface (oxide film removing step); a step of drying the anode layer, from which the oxide film is removed, under an inert gas atmosphere such as Ar (drying step); a step of cooling the dried anode layer under an inert gas atmosphere such as Ar (cooling step); a step of transferring the cooled anode layer to an assembling area where a battery is to be assembled (transfer step); and a step of assembling a nonaqueous secondary battery in the assembling area using the anode layer under an inert gas atmosphere such as Ar (assembling step).

Hereinafter, the method of producing a nonaqueous secondary battery of the present invention will be explained by each step.

### 1. Anode Layer Forming Step

First, the anode layer forming step of the present invention will be explained. The anode layer forming step of the present invention is a step of forming an anode layer of metal thin film on an anode current collector. In the present invention, the resultant where an anode layer is formed on an anode current collector may be referred to as “anode”.

In the present invention, an anode layer of metal thin film is formed on an anode current collector. The “metal thin film” of the present invention denotes a dense metal thin film and does not include a porous body such as a sintered body. Further, an anode layer where a powdery anode active material is fixed with a resin binder is not included in the anode layer used in the present invention. On the other hand, as mentioned later, a metal thin film obtained by a method such as a PVD (Physical Vapor Deposition) or a CVD (Chemical Vapor Deposition) is included in the anode layer used in the present invention.

A metal constituting the anode layer is not particularly limited as long as it can store and discharge Li ion or the like and can form an oxide film by contacting the air. Mentions can be made of Sn, Sn alloys, Si, Si alloys, Li and Li alloys, and among them, Sn, Sn alloys, Si, and Si alloys are preferable.

Film thickness of the anode layer varies depending on factors such as an application of a nonaqueous secondary battery to be obtained, but normally, it is within the range of 1 μm to 100 μm, and preferably within the range of 1 μm to 10 μm.

On the other hand, the anode current collector used in the present invention is not particularly limited and an anode current collector used for a general nonaqueous secondary battery can be used. Mentioned can be made of a film where a metal such as copper or nickel is processed into a plate form. Further, in the present invention, a foamed substrate and the like can be used. As a material for the foamed substrate, Ni, Cu and the like can be cited. The surface area of the foamed substrate is not particularly limited, but it is normally within the range of 1000 m²/m³ to 15000 m²/m³.

A method of forming the anode layer on the anode current collector is not particularly limited and methods such as a sputtering method, a PVD method, a CVD method, an electrolytic plating method, and a nonelectrolytic plating can be cited. Among them, a sputtering method and an electrolytic plating method is preferable.

### 2. Oxide Film Removing Step

The oxide film removing step of the present invention is a step of removing an oxide film formed on the anode layer surface. The method of removing an oxide film from the anode layer is not particularly limited as long as the oxide film can be removed from the anode layer surface. For example, an acid washing, an alkali washing, a plasma cleaning, and polishing can be cited and among them, an acid washing is preferable. Further, a cleaning liquid used for a general acid cleaning can be used as a cleaning liquid for the above-mentioned acid cleaning. More specifically, a cleaning liquid of hydrochloric acid, sulfuric acid, nitric acid, phosphoric acid and a mixed liquid thereof can be cited.

Further, as examples of a method to remove the oxide film from the anode layer surface, a method of removing the oxide film by coating the cleaning liquid to the anode layer surface, and a method of removing the oxide film by immersing the anode layer to the cleaning liquid can be cited.

In the present invention, it is preferable to conduct the oxide film removing step so as to make the metallic oxide present on the anode layer surface becomes 1% or lower, particularly 0.1% or lower. The metallic oxide present on the anode layer surface can be confirmed by an XPS or the like.

In the present invention, an aqueous cleaning is generally carried out after the removal of the oxide film.

### 3. Drying Step

The drying step of the present invention is a step of drying the anode layer, from which the oxide film is removed, under an inert gas atmosphere.

The inert gas used in the present invention is not particularly limited as long as it can prevent the formation of oxide film on the anode layer surface. For example, a rare gas such as Ar and He, and N₂ can be cited. Among them, Ar is preferable because it is chemically stable and relatively affordable. In the present invention, the anode layer is dried under the oxygen concentration of preferably 10 ppm or less, particularly 1 ppm or less.

The drying temperature is not particularly limited as long as the moisture or the like on the anode layer surface can be removed. It is generally within the range of 60° C. to 200° C. and preferably within the range of 110° C. to 150° C. The drying temperature can be measured by thermocouple and the like. Further, the time for drying varies depending on factors such as the above-mentioned dry temperature or the like. It is generally within the range of 5 minutes to 48 hours, and preferably within the range of 3 hours to 24 hours. A method to dry the anode layer is not particularly limited as long as the moisture or the like on the anode layer surface can be removed. Specifically, a method to maintain the anode layer in a dry room to dry can be cited as an example. Further, in the present invention, the anode layer may be dried by batch or by continuously moving the anode layer in the dry room where a temperature is set to the above-mentioned temperature.

### 4. Cooling Step

The cooling step of the present invention is a step of cooling the anode layer under an inert gas atmosphere after the above-mentioned drying step.

In the present invention, it is preferable to cool the anode layer to a temperature of 10° C. or lower, more preferably to a temperature of 0° C. or lower, or even more preferably to a temperature of −10° C. or lower in the cooling step. Thereby, forming of the oxide film can be restrained. On the other hand, the lower limit to cool the anode layer is not particularly limited, but it is generally preferable to set the limit to −110° C. or higher, and more preferably to 180° C. or higher.

A method to cool the anode layer is not particularly limited as long as the method allows the anode layer to be cooled to the specific temperature. More specifically, a method to maintain the anode layer and to cool it can be cited as an example. Further, in the present invention, the anode layer may be cooled by a batch method, or by continuing moving the anode layer in a cooling room where the temperature thereof is set to the above-mentioned range.

As the inert gas used in the cooling step is the same as the one explained in the above-mentioned section of “3. Drying step”, explanation here is omitted. In particular, in the present invention, it is preferable to cool the anode layer under the inert gas atmosphere without allowing the anode layer to contact to the air after the drying step. Thereby, forming of the oxide film can be restrained.

### 5. Transfer Step

The transfer step of the present invention is a step of transferring the anode layer to an assembling area after the above-mentioned cooling step. The “assembling area” of the present invention denotes an area where a nonaqueous secondary battery is assembled.

As the anode layer is cooled in the above-mentioned cooling step, the anode layer is made to a state where an oxide film is less likely to form on the anode layer surface. Therefore, it is possible to transfer the anode layer to the assembling area at an ordinary temperature and a pressure in the transfer step. However, when the anode layer is left at an ordinary temperature and a pressure for a long time, the temperature of the cooled anode layer may possibly reach to the room temperature and lose the point of the previous cooling. In such a situation, it is preferable to transfer the anode layer while it has a low temperature by shorten the transfer time or the like. As it will be explained later, in the present invention, it is preferable that the anode layer is cooled to at a temperature of 15° C. or lower at the time of going through the transfer step to the assembling step.

In the present invention, the cooled anode layer is preferably maintained at 10° C. or lower, more preferably at 0° C. or lower, and even more preferably at −10° C. or lower at the time of the transfer step. Thereby, forming of the oxide film can be more restrained compare to the case when the anode layer is transferred at ordinary temperature. On the other hand, as the lower limit of the cooling temperature for cooling the anode layer is the same as the one explained in the above-mentioned section of “4. Cooling step”, the explanation here is omitted. In particular, in the present invention, the anode layer is preferably transferred at the same temperature as the cooling temperature used in the cooling step.

In the present invention, it is preferable to transfer the cooled anode layer to the assembling area under an inert gas atmosphere at the time of the transfer step. By making the transfer under the inert gas atmosphere, forming of the oxide film can be restrained. In particular, in the present invention, it is preferable to transfer the anode layer under an inert gas atmosphere after the cooling step without allowing the anode layer to contact to the air. As the inert gas used in the transfer step is the same as the one explained in the above-mentioned section of “3. Drying step”, explanation here is omitted.

### 6. Assembling Step

The assembling step of the present invention is a step of assembling a nonaqueous secondary battery under an inert gas atmosphere by using the anode layer transferred to the assembling area. As the assembling step is conducted under an inert gas atmosphere, the assembling area is an area hermetically-closed. As one example of the assembling area, a glove box can be cited.

In the present invention, the anode layer is preferably cooled at 15° C. or lower, more preferably at 5° C. or lower, and even more preferably at −5° C. or lower. Thereby, forming of the oxide film can be restrained. On the other hand, as the lower limit of the temperature to cool the anode layer is the same as those mentioned in the above-mentioned section of “4. Cooling step”, the explanation here is omitted.

In the assembling step, a cathode, a separator, an electrolyte solution and a battery case is used other than the above-mentioned anode, and others such as a spacer and a wave washer can be used as needed. As general materials used for the nonaqueous secondary battery can be used for the above-mentioned materials, explanation here is omitted. Further, a shape of the nonaqueous secondary battery obtained in the present invention is not particularly limited, but a coin type, a button type, a sheet type, a cylindrical type and a squareness type can be cited as examples.

Further, in the present invention, it is preferable to conduct all of the above-mentioned drying step, cooling step and assembling step under an inert gas atmosphere. Thereby, forming of the oxide film can be restrained. Moreover, in the present invention, it is preferable to conduct all of the cooling step, transfer step and assembling step at the specific cooling temperature. As the specific cooling temperature is the same as the one mentioned in the above-mentioned section of “4. Cooling step”, explanation here is omitted.

The present invention is not limited to the above-described embodiments. The above embodiments are mere illustrative, and the present invention encompasses any embodiments that have substantially the same constitution and exhibit the same working effect as by the technical idea described in the claims in the present application.

### Examples

Hereinafter, the present invention is described in more detail by reference to the Examples.

### Example 1

A foamed substrate made of Ni (Surface area: 8500 m²/m³, manufactured by Sumitomo Electric Industries, Ltd.) was prepared and a Sn thin film (film thickness: 1 μm) was formed thereon by electrocrystallization and an anode (working electrode) was obtained. Next, an oxide film on the Sn thin film was removed by immersing the anode to a HCl aqueous solution of 10% by weight for five minutes, and an aqueous cleaning was carried out to the resultant and subsequently dried under Ar atmosphere at 120° C. for 12 hours. The anode was then cooled to 10° C. under the Ar atmosphere, and transferred to a glove box with the Ar atmosphere. Further, lithium metal was prepared as a counter electrode and a coin type cell was produced in the above-mentioned glove box by the following manner as explained below while maintaining the temperature of the anode substantially at the same value.

First, the above-mentioned counter electrode is provided on the bottom surface of the coin type cell case, and a polyolefin based separator was then provided on the counter electrode. Next, an electrolyte solution was dropped on the separator. The electrolyte solution used was prepared by mixing EC (ethylene carbonate) and DMC (dimethyl carbonate) at a volume ratio of 3:7, and by dissolving lithium hexafluorophosphate (LiPF₆) as a supporting salt into the mixture so as to make the concentration thereof to 1 mol/L. Then, the followings were provided: a packing on the separator, the above-mentioned anode in the inner side of the packing, a spacer and a wave washer on the anode, and a cap can on the wave washer. By crimping the cap can to the case can, a coin type cell was obtained.

### Example 2

A coin type cell was obtained in the same manner as in the Example 1 except that the cooling temperature of the anode was made to 0° C.

### Example 3

A coin type cell was obtained in the same manner as in the Example 1 except that the cooling temperature of the anode was made to −10° C.

### Comparative Example 1

A coin type cell was obtained in the same manner as in the Example 1 except that the anode was not cooled but dried at room temperature (25° C.).

### [Evaluation]

To the respective coin type cells obtained in the Examples 1 to 3 and the Comparative Example 1, CC (constant current/constant voltage) was charged up to 10 mV and was discharged till 1.5 V. Using the obtained charging capacity and discharging capacity, the respective initial charge-discharge efficiency was calculated with the below-mentioned formula:

initial charge-discharge efficiency (%)=discharging capacity/charging capacity×100.

Obtained results are shown in the Table 1.

TABLE 1

| | | | | Comparative |
|---|---|---|---|---|
| | Example 1 | Example 2 | Example 3 | Example 1 |
| Temperature (° C.) | 10 | 0 | −10 | 25 |
| Initial | 82.4 | 85 | 86.5 | 79.1 |
| charge-discharge | | | | |
| efficiency (%) | | | | |

The relation between the temperature (° C.) and the initial charge-discharge efficiency (%) is shown in FIG. 2. From the table 1 and FIG. 2, it was affirmed that cooling of the anode could restrain the formation of oxide film to the anode layer surface and improve the respective initial charge-discharge efficiency (%) of the nonaqueous secondary batteries obtained.

1.-5. (canceled)

6. A method of producing a nonaqueous secondary battery comprising steps of:
an anode layer forming step of forming an anode layer of metal thin film on an anode current collector;
an oxide film removing step of removing an oxide film formed on the anode layer surface;
a drying step of drying the anode layer, from which the oxide film is removed, under an inert gas atmosphere;
a cooling step of cooling the dried anode layer under an inert gas atmosphere;
a transfer step of transferring the cooled anode layer to an assembling area: and
an assembling step of assembling a nonaqueous secondary battery under an inert gas atmosphere by using the anode layer transferred to the assembling area.

7. The method of producing a nonaqueous secondary battery according to claim 6, wherein the anode layer is cooled to a temperature of 10° C. or lower in the cooling step.

8. The method of producing a nonaqueous secondary battery according to claim 6, wherein the cooled anode layer is maintained at 10° C. or lower in the transfer step.

9. The method of producing a nonaqueous secondary battery according to claim 6, wherein the cooled anode layer is transferred to the assembling area under an inert gas atmosphere in the transfer step.

10. The method of producing a nonaqueous secondary battery according to claim 6, wherein the anode layer is cooled at 15° C. or lower in the assembling step.
